(19) United States
(12) Patent Application Publication
(10) Pub. No.: US 2002/0077854 A1
(43) Pub. Date: Jun. 20, 2002

(54) Software and method of coding treatment and recording progress of rehabilitation services

(76) Inventor: James A. Porterfield, Hudson, OH (US)

Correspondence Address: Daniel A. Thomson, Esq., One Cascade Plaza, Fourteenth Floor, Akron, OH, 44308-1147, US

(21) Appl. No.: 09/954,927

(22) Filed: Sep. 18, 2001

Related U.S. Application Data
(60) Provisional application No. 60/255,440, filed on Dec. 14, 2000.

(51) Int. Cl. G06F 17/60

(52) U.S. Cl. 705/2

(57) ABSTRACT

A new and improved method and apparatus for coding treatment and recording the progress of rehabilitation services per diagnosis. The process uses a weighting system on clinical visit slips, in association with a software program, payer restrictions, CPT codes, internal expected payments, and relative value units to determine the most appropriate billing scenario.

This application claims priority to a provisional patent application, U.S. Ser. No. 60/255,440, entitled SOFTWARE AND METHOD OF RECORDING PROGRESS OF REHABILITATION TREATMENT, filed Dec. 14, 2000. The Provisional Application is incorporated herein by reference. A microfiche appendix is included with this patent application.

### I. BACKGROUND OF THE INVENTION

A. Field of the Invention

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

This invention relates to the art of medical claims processing, and more particularly to the art of integrating medical treatment with medical billing, and even more particularly to a process by which the best billing scenario is selected for each treatment.

The inventive process allows integration and reports to aid with all aspects of the medical business, including converting clinical language (i.e. profession specific terms) into billing language (CPT codes (Current Procedural Terminology)), yielding the appropriate billing scenario. The CPT codes are owned and provided by the AMA. By placing the rules of the payer into the computer along with payment patterns, the process permits the clinician to focus on the care of the patient, with the process computer program providing efficient coding for the medical intervention, redefining the definition of intervention per diagnosis. The inventive process prevents the submission of billing codes that will be refused or reduced unnecessarily.

The daily visit slips, which serves as a vehicle that converts clinical information and/or terms into billing codes, containing clinical information and/or terms are printed, checked, and weighted by the clinician, and the process obtains the best coding scenario, while allowing the clinician to track treatment behaviors by diagnosis and groups of diagnoses. The inventive process evaluates the treatment, the submitted possible CPT codes, the payer restrictions, payment behaviors, and the expected payments and suggests the best billing scenario.

B. Description of the Related Art

Currently, two of the biggest problems faced by the medical profession are the requirement that the clinician understand payer rules and be able to describe their treatment per diagnosis via CPT codes and increased denials and decreased payment for services rendered.

Recently, the medical field has begun to utilize computer devices and methods in the effort to make the recordation and billing of patient related data more efficient. Specifically, computers and computer programs are being used to determine correct CPT or other standard billing codes for clinical services rendered. None of the present methods utilize the integration of a visit slip with clinical language converted into billing codes.

The inventive process helps 1) free the clinician from having to remember all the payer rules and restrictions, 2) promote compliance with the government mandated 15-minute rule for CPT codes, 3) standardize the practice; and 4) maximize reimbursements.

The present invention provides a new and improved apparatus and method for integrating and processing medical claims, and overcomes certain difficulties inherent in the related inventions while providing better overall results.

### II. SUMMARY OF THE INVENTION

In accordance with one aspect of the present invention, a method of determining the best billing scenario for physical therapy practice treatments includes providing a logic, providing at least one clinical treatment code, providing at least one payer restriction, providing at least one relative value unit, providing expected payment, providing a weighting value system based on certain criteria, evaluating treatments based upon the value system, assigning a weighting value to each treatment, entering the treatment weighting and the clinical treatment code into the logic, and suggesting a billing scenario based on the expected payment, relative value units, and the payer restriction.

In accordance with another aspect of the present invention, a method of determining a medical billing scenario includes providing a logic, providing at least one clinical treatment code, weighting a treatment, entering the treatment weighting and the clinical treatment code into the logic, and determining the best billing scenario.

In accordance with yet another aspect of the present invention, the method also includes the steps of providing at least one payer restriction, providing at least one relative value unit, providing expected payments, and converting the at least one clinical term code into at least one billing code.

In accordance with another aspect of the present invention, the method includes providing the treatment weighting, the clinical treatment code, the relative value unit, the expected payments, and the payer restriction, suggesting a billing scenario based on the expected payment, providing a weighting value system based on certain criteria, evaluating treatments based upon the value system, assigning a weighting value to each treatment, providing a visit slip, the visit slip containing clinical information, converting the clinical information into billing language, accessing a database through a global computer network, accessing a patient account, providing a visit slip, the visit slip containing clinical information, and utilizing the visit slip to document services provided, time in an associated clinic, and alterations in an associated patient's condition.

In accordance with still another aspect of the present invention, the method includes analyzing past charging behaviors, determining expected payment, creating reports based on the visit slip, utilizing the reports to define clinical practice.

In accordance with yet another aspect of the present invention, a computer readable medium for implementing a method, the method including providing a logic, providing at least one clinical treatment code, weighting a treatment, entering the treatment weighting and the clinical treatment code into the logic, determining the best billing scenario based on the at least one relative value unit, the expected payment, the treatment weighting, and the clinical treatment code.

In accordance with another aspect of the present invention, the computer readable medium includes entering the treatment weighting and the clinical treatment code into the logic, suggesting a billing scenario based on the internal expected payment, the payer restriction, the relative value unit, the treatment weighting, and the clinical treatment code, providing a weighting value system based on certain criteria, evaluating treatments based upon the value system, assigning a weighting value to each treatment, providing a visit slip, the visit slip containing clinical information, converting the clinical information into billing language, accessing a database through a global computer network, and accessing a patient account.

In accordance with yet another aspect of the present invention the computer readable medium includes providing a visit slip, the visit slip containing clinical information, utilizing the visit slip to document services provided, time in an associated clinic, and alterations in an associated patient's condition, analyzing past charging behaviors, determining expected payment, creating reports based on the visit slip, and utilizing the reports to define clinical practice.

### III. DESCRIPTION OF THE INVENTION

With reference to the present invention, the visit slip was designed by clinicians to be used as a vehicle to describe clinical practice, and at the same time, aid the front office in running the coding portion of the inventive process. The visit slip allows the clinician to focus on the patient, while not being held responsible for understanding the complexities of accurately coding (i.e. CPT billing codes) the practice. The present embodiment can be defined in the following seven steps: 1) print the visit slip via centralized software; 2) visit slip contains clinical terms, modalities, and supplies; 3) clinician identifies terms and weights them (i.e. 3, 2, 1); 4) the front office enters the treatment information into the correct clinical treatment code; 5) the software utilizes terms, weighting value, expected payments, relative value units, payer specific reimbursements, and/or payer restrictions and rules, which yields the best billing scenario; 6) the front office trouble shoots the suggested CPT code, and then once approved, 7) the CPT code is entered into the billing software.

The visit slip provides the clinician with pertinent information about the patient, including any past visits, and functions as a vehicle to permit the transformation of clinical language (i.e. activities performed by the clinical staff) into billing language (i.e. selecting the appropriate CPT code for the rendered service). The visit slip contains clinical terms, modalities, and supplies, which can all be assigned a clinical treatment code. In this embodiment, the clinical treatment code is arbitrarily assigned by the physical therapy office, but any method for assigning the treatment codes may be used, as long as chosen using sound engineering judgment.

The visit slip contains clinical terms chosen and described by the clinical staff. In this embodiment, the visit slip is divided into two portions, where the top portion is administrative and the bottom portion is clinical. The portions are divided again into two more portions, with the top left containing patient information and time of treatment, and the top right portion containing clinical information (i.e. date of first and last visit, last visit charge, diagnosis, secondary assessment, clinical treatment codes, and clinical intervention performed). The clinical treatment codes, in this embodiment, are arbitrary numbers assigned to each treatment. The inventive process automatically converts the clinical treatment codes into the appropriate CPT codes. The clinical treatment code could be set up in any manner using sound business and medical judgment. The bottom left portion contains clinical terms, which in this embodiment are divided into evaluation, hands on, exercise, education, and other. The bottom right section provides an area to check modalities used and supplies provided, as well as a blank space to write in CPT codes produced by the inventive process.

During, or after, the patient's treatment, the clinician utilizes the visit slip to rate the clinical procedures. The weighting of the treatments allows the clinician to better focus the treatment, know what phase of recovery the patient is in, as well as allow the billing scenario to be more accurate and efficient.

In this embodiment, the process is utilized, by the clinician, via a global computer network such as the world wide web. It is to be understood, however, that this process can be implemented using any computer or network system, as long as chosen using sound engineering and business judgment. Once the clinician, or other user of the process, accesses the global computer network, the software for the inventive process is accessed. In this embodiment, the software contains restrictions and security measures to ensure that only the appropriate user accesses their information.

In this embodiment, the inventive software also contains restrictions and warnings (i.e. interventions and frequency of interventions that payer will not reimburse clinician for) established as a result of recognizing and learning the payment behaviors of the various payers. The coding portion of the process utilizes this information, coupled with the visit slip information, to choose the appropriate CPT code. The expected payment, the payer restrictions, and the relative value units are internal to the system, and are part of the logic (by “logic” it is meant integrating CPT codes and clinical treatment codes by turning clinical treatment codes into CPT codes). However, it is to understood that it is possible that there will be no payer restrictions.

To start the process, the clinician, utilizing the visit slip, chooses the appropriate procedures performed on that day and provides a measure of importance or relevance to each treatment. In this embodiment, the clinician uses descending numbers, wherein “3” is the most relevant and “1” is the least relevant. There is no limit to the number of terms marked, and no limitation on what levels of relevance may imposed, except that, in this embodiment, there must always be at least one “3.”

In using the information on the visit slip, the process can quantify the progression of treatment per diagnosis or groups of diagnoses. As the patient heals, the treatment most often changes from modality and “hands on,” to strength training, and the process can track the progression of the treatment.

Once the treatment process is defined and/or carried out, the information from the visit slip is entered into the software and the appropriate billing scenario is determined by comparing the CPT code, the payer restrictions, and the expected payment, along with the weighting system of the visit slip. The process can work with any number of clinical treatment codes being entered. For example, only one treatment code may be entered, but there may be four different 15-minute treatment units. For example, sixty minutes of resistance exercise can yield four units, which could be one CPT code. The process will integrate the treatment codes with the logic, expected payment, relative value unit, etc., to determine the best manner of coding the four treatments.

In this embodiment, the clinician, or designated staff, reviews and approves each code prior to entry into the billing software, so as to ensure the accuracy of the software. The inventive process may, however, electronically determine the expected payments from an analysis of past coding behaviors.

Once the inventive process has been implemented, the user will be able to run reports from a wide variety of variables, such as diagnosis, provider, payor, and other variables on the clinical visit slip. This allows the clinician to better define their practice as to what services are being performed on what group of patients.

In this embodiment, the reports can be divided into four sections—1) reports used to define practice; 2) train the staff to standardize the treatment per diagnosis; 3) market services; and 4) maximize reimbursement. These reports are merely embodiments of the invention and are not intended to limit it in any manner.

### EXAMPLE 1

A patient is prescribed 20 visits to rehabilitate a sprained/strained cruciate ligament. In the fourth visit, the patient is at the clinic for a total of forty-five minutes and the clinician performs three clinical procedures—joint mobilization, soft tissue mobilization, and assisted exercise. Also used during the visit were two modalities—hot packs/cold packs and a vasopneumatic device. During, or after, the treatment, the clinician fills out the visit slip and assigns the three clinical procedures a “3” on the weighting system as being most relevant, a “3” to the vasopneumatic device and a “2” to the hot packs/cold packs.

Each procedure and modality has at least one clinical treatment code associated with it. It is possible that a treatment could have multiple clinical treatment codes associated with it, either because the treatment is really more than one procedure, or the treatment could be labeled in more than one category. The inventive process takes the assigned clinical treatment codes, the visit slip rates, the payer restrictions associated with the treatments and/or CPT codes, the internal expected payment, the RVU (relative value unit, as defined by the AMA) and determines the best CPT code to bill to the payer/insurance company. A relative value unit is determined by analyzing three parameters for each CPT code. The three parameters are 1) how much is the cost for liability insurance; 2) geographic region the procedure is being performed in; and 3) the skill level required for performing the procedure.

The inventive process allows the user to update, modify, or delete individual payer rules and restrictions. The carrier providers often modify their rules and restrictions, as well as different states have different laws concerning billing procedures. The inventive process provides the opportunity for the customer to customize the process in accordance with the changes or modifications.

It is to be understood that the mode of accessing the inventive process can be any mode chosen using sound engineering judgment. In one embodiment, the database is accessed via a global computer network, but in another embodiment, the database is accessed via centralized data software.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method of determining the best billing scenario for physical therapy practice treatments, the method comprising the steps of:
providing a logic;
providing at least two clinical treatment codes;
providing at least one payer restriction;
providing at least one relative value unit;
providing expected payment;
providing a weighting value system based on certain criteria;
evaluating treatments based upon the value system;
assigning a weighting value to each treatment;
entering the treatment weighting, the clinical treatment codes, and the relative value unit into the logic;
analyzing the treatment weighting, the clinical treatment codes, the relative value unit, the expected payments, and the payer restriction;
converting the clinical treatment codes into billing codes; and,
suggesting a billing scenario based on the relative value unit, the payer restriction, and the expected payment.

2. A method of determining a medical billing scenario, the method comprising the steps of:
providing a logic;
providing at least one clinical treatment code;
weighting a treatment;
entering the treatment weighting and the clinical treatment code into the logic; and,
determining the best billing scenario based on the treatment weighting and the clinical treatment code.

3. The method of claim 2, wherein the method further comprises the steps of:
providing at least one payer restriction;
providing at least one relative value unit;
providing expected payments; and,
converting the at least one clinical treatment code into at least one billing code.

4. The method of claim 3, wherein determining the best billing scenario based on the treatment weighting and the clinical treatment code comprises the step of:
determining the best billing scenario based on the treatment weighting, the clinical treatment code, the at least one payer restriction, the relative value unit, and the expected payments.

5. The method of claim 4, wherein determining the best billing scenario comprises the step of:
suggesting a billing code based on the internal expected payment.

6. The method of claim 5, wherein weighting a treatment comprises the steps of:
providing a weighting value system based on certain criteria;
evaluating treatments based upon the value system; and,
assigning a weighting value to each treatment.

7. The method of claim 6, wherein the method further comprises the steps of:
providing a visit slip, the visit slip containing clinical information; and,
converting the clinical information into billing language.

8. The method of claim 2, wherein the method further comprises the steps of:
accessing a database through a global computer network; and,
accessing a patient account.

9. The method of claim 8, wherein the method further comprises the steps of:
providing a visit slip, the visit slip containing clinical information; and,
utilizing the visit slip to document services provided, time in an associated clinic, and alterations in an associated patient's condition.

10. The method of claim 7, wherein providing expected payments comprises the steps of:
analyzing past charging behaviors; and,
determining expected payment.

11. The method of claim 10, wherein the method further comprises the steps of:
creating reports based on the visit slip; and,
utilizing the reports to define and quantify clinical practice.

12. A computer readable medium for implementing a method, the method comprising the steps of:
providing a logic;
providing at least one clinical treatment code;
weighting a treatment;
entering the treatment weighting and the clinical treatment code into the logic; and,
determining the best billing scenario based on the treatment weighting and the clinical treatment code.

13. The computer readable medium of claim 12, wherein the method further comprises the steps of:
providing at least one payer restriction;
providing at least one relative value unit;
providing expected payment; and,
converting the at least one clinical code into at least one billing code.

14. The computer readable medium of claim 13, wherein determining the best billing scenario based on the treatment weighting and the clinical treatment code comprises the step of:
determining the best billing scenario based on the treatment weighting, the clinical treatment code, the at least one payer restriction, the relative value unit, and the expected payment.

15. The computer readable medium of claim 14, wherein weighting a treatment comprises the steps of:
providing a weighting value system based on certain criteria;
evaluating treatments based upon the value system; and,
assigning a weighting value to each treatment.

16. The computer readable medium of claim 15, wherein the method further comprises the steps of:
providing a visit slip, the visit slip containing clinical information; and,
converting the clinical information into billing language.

17. The computer readable medium of claim 12, wherein the method further comprises the steps of:
accessing a database through a global computer network; and,
accessing a patient account.

18. The computer readable medium of claim 17, wherein the method further comprises the steps of:
providing a visit slip, the visit slip containing clinical information; and,
utilizing the visit slip to document services provided, time in an associated clinic, and alterations in an associated patient's condition.

19. The computer readable medium of claim 16, wherein providing expected payments comprises the steps of:
analyzing past charging behaviors; and,
determining expected payment.

20. The computer readable medium of claim 19, wherein the method further comprises the steps of:
creating reports based on the visit slip; and,
utilizing the reports to define clinical practice.
